(19) United States
(12) Patent Application Publication
(10) Pub. No.: US 2006/0098105 A1
(43) Pub. Date: May 11, 2006

(54) Digital camera and computer program

(75) Inventors: Noriyuki Okisu, Osakasayama-shi (JP); Shinichiroh Noda, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/068,324

(22) Filed: Feb. 28, 2005

(30) Foreign Application Priority Data
Nov. 5, 2004 (JP) 2004-321649

(51) Int. Cl. H04N 5/76

(52) U.S. Cl. 348/231.99

(57) ABSTRACT

A digital camera is provided which allows easy recognition of what images are stored in a folder created on a recording medium when viewed from a personal computer. The digital camera stores photographed images in folders on a removable recording medium. In response to an instruction given by the user (step #200), a specified image (#206) is determined as an image that represents all the images stored in the folder which includes that image, and then data that marks it as a representative image is recorded in the tag of the image file of the image (#208). When searching the recording medium, the personal computer identifies the representative image based on the above-mentioned data and displays the representative image in a manner superimposed on the image of the folder.

This application is based on Japanese Patent Application No. 2004-321649 filed on Nov. 5, 2004, the contents of which are hereby incorporated by reference.

### BACKGROUND OF THE INVENTION

1. Field of the Invention

The present invention relates to a digital camera for recording photographed images on a recording medium as image files, and a computer program for reading image files from such a recording medium.

2. Description of Related Art

Images photographed with a digital camera are played back for display and edited on a personal computer. The digital camera creates image files representing the photographed images and records the created image files on a recording medium. The personal computer reads the image files from the recording medium of the digital camera. The image files may be read via a cable that connects the personal computer and the digital camera. Alternatively, the image files may be read by the use of a removable recording medium that can be detached from the digital camera so as to be mounted on the personal computer.

Both the digital camera and the personal computer store image files in folders. With the personal computer, the user can create folders for storing image files therein. The user can classify image files by storing them in different folders for easier management. With the digital camera, the number of folders for storing image files is conventionally limited to one. In some recent digital cameras, a plurality of folders can be created on the recording medium so that the folder in which the image files are stored can be switched.

In the personal computer, the names of files and folders are displayed so that the user can identify these files and folders. Moreover, the images of files and the images of folders are displayed to further facilitate the identification. The images of files and the images of folders are displayed in different forms, thereby allowing the user to discriminate the files and folders at first sight.

Furthermore, in one brand of OS (Operating System) for the personal computer, namely Windows (a registered trademark of Microsoft Corporation) XP, a reduced image of one of the image files stored in a folder is displayed superimposed on the image of this folder. Displaying the image of an image file stored in a folder in a manner superimposed on the image of the folder in this way allows the user to easily recognize what images the folder stores. The user can specify the image file of the image to be displayed superimposed on the image of the folder. Up to four such images can be displayed simultaneously.

Japanese Patent Application Lain-Open No. 2003-339013 discloses a computer in which an image to be displayed superimposed on the image of a folder is set automatically. In this computer, the display time of each image is measured when it is played back for display, and the image kept displayed for the longest display time is set to be the one displayed superimposed on the image of the folder for display.

The above-mentioned OS function for displaying the image of the image file specified by the user in a manner superimposed on the image of the folder can also be used for the purpose of searching the recording medium of the digital camera connected via the cable or directly attached to the personal computer with a view to looking through folders created on the recording medium. However, moving (or copying) image files from the recording medium of the digital camera to the personal computer causes the loss of the information on the specified image file. As a result, when the image of the folder is displayed on the personal computer, no image is displayed on the folder. Therefore, the image file needs to be specified again to make the image displayed superimposed on the folder.

In many cases, the general user moves (copies) image files from the recording medium of the digital camera to the recording medium of the personal computer since no more new image can be photographed unless the image files are deleted from the recording medium of the digital camera. In such a case, which folders have stored which image files is ambiguously memorized, because a large number of image files have been stored and also a long period of time has passed since the images were photographed. Thus, in order to determine the image to be displayed superimposed on the folder on the personal computer, a great number of images need to be displayed to examine the contents thereof, which requires a long period of time.

According to the above-mentioned conventional technique, after the image of one or more image files are displayed on the computer, the image to be superimposed on the image of the folder is automatically specified, which is convenient. However, the judgment on which image is to be displayed superimposed on the image of the folder is based on the period of time for which it is kept displayed on the computer. Therefore, the image to be displayed superimposed on the image of the folder cannot be specified until the image of at least one image file is displayed at least once. Accordingly, even when an image has been displayed on the digital camera, no image is displayed superimposed on the image of the folder immediately after the image file of the image is moved from the recording medium of the digital camera to the recording medium of the computer.

### SUMMARY OF THE INVENTION

In view of the conventionally encountered problems described above, it is an object of the present invention to provide a digital camera and a program for a personal computer that allow easy recognition of what images are contained in the image files stored in a folder created on a recording medium when viewed from a personal computer, and also that, even after the image files are moved from the recording medium to the personal computer, allow easy recognition of what images are contained in the image files included in the folder storing the moved image files.

To achieve the above-mentioned object, according to one aspect of the present invention, a digital camera for storing photographed images as image files in a folder created on a recording medium, specifies the image of one of the image files stored in the folder as a representative image that represents all the image files stored in the folder. Then the digital camera records, in the image file of the representative image, data that marks a representative image.

When the folder created on the recording medium of this digital camera is searched from a personal computer, the representative image can be displayed superimposed on the image of the folder. This makes it easy to recognize what images are contained in the image files stored in the folder. Furthermore, the data that marks the representative image is recorded in the image file itself of the representative image. Thus, even when the image of the folder that stores the image file of the representative image is displayed after this image file is read into the personal computer, the representative image can be displayed superimposed on the image of the folder.

The data that marks the representative image may be recorded in a tag (header) of the image file. Each file contains a tag (header) for recording predetermined data such as the file type. Using the tag allows the data marking the representative image to be recorded in the image file itself without requiring the image file to be specially structured.

The images of the image files stored in the folder may be displayed side-by-side in response to an instruction given by a user. If the representative image is included in the displayed images, an indication that marks a representative image may be added to the representative image. This permits the user to easily recognize whether or not the image is the representative image.

The images of the image files stored in the folder may be displayed side-by-side to permit the user to specify one of the displayed images so that the specified image may be determined as the representative image. This permits the user to determine an image he or she desires as the representative image. In addition, this can be achieved through easy operation.

As the representative image, images of a plurality of image files stored in the folder may be determined. Specifying a plurality of images as the representative image allows a plurality of images to be displayed superimposed on the image of the folder on the personal computer. This makes it easier to recognize what images are contained in the image files stored in the folder.

The digital camera may have a photographing mode, in which a newly photographed image is associated with the image of one of the image files stored in the folder and data indicating association between the images is recorded on the recording medium. Thus, when an image is photographed in the photographing mode, the image with which the newly photographed image is associated may be determined as the representative image. Recording the association between images can enhance the images' capability to convey information. Moreover, since the same image can be associated with a plurality of new images, determining such an image as the representative image allows easier recognition of what images are contained in the image file stored in the folder.

As above-mentioned folder, a plurality of folders may be created on the recording medium, and representative images may be determined on a folder-by-folder basis. Providing a plurality of folders allows image classification on the digital camera. Moreover, determining the representative image on a folder-by-folder basis allows easier recognition of the correspondence between the classified images and the image files.

To achieve the above-mentioned object, according to another aspect of the present invention, a program is provided for making a computer search a recording medium of a digital camera that stores photographed images as image files in a folder created on the recording medium so as to display an image of the folder created on the recording medium. The program includes commands for making the computer execute the following steps. A first step is provided for checking whether or not any of the image files stored in the folder contains data recorded to mark the image of aforementioned image file as a representative image that represents all the image files stored in the folder. A second step is provided for displaying, if none of the image files stored in the folder contains data recorded to mark a representative image, only the image of the folder, or if any of the image files stored in the folder contains data recorded to mark a representative image, the image of that image file in a manner superimposed on the image of the folder.

The personal computer that operates in accordance with this program, depending on whether or not the image file of the representative image is included in the image files stored in the folder on the recording medium of the digital camera, can make switching between the following two operations: displaying only the image of the folder and displaying the representative image in a manner superimposed on the image of the folder. The user can recognize what images are contained in the image files stored in the folder, based on the representative image displayed superimposed on the image of the folder. A search of the recording medium of the digital camera can be performed with the personal computer and the digital camera connected together, or by the use of a removable recording medium that can be mounted on the personal computer.

To achieve the above-mentioned object, according to still another aspect of the present invention, a program is provided for making a personal computer read, from a recording medium of a digital camera that stores photographed images as image files in a folder created on the recording medium, image files into a folder created in a storage portion of the personal computer and then display an image of the folder created in the storage portion. The program includes commands for making the computer execute the following steps. A first step is provided for checking whether or not any of the image files stored in the folder in the storage portion contains data recorded to mark the image of aforementioned image file as a representative image that represents all the images of the image files stored in the folder. A second step is provided for displaying, if none of the image files stored in the folder contains data recorded to mark a representative image, only the image of the folder or, if any of the image files stored in the folder contains data recorded to mark a representative image, the image of that image file in a manner superimposed on the image of the folder.

The personal computer that operates in accordance with this program, after reading image files from the recording medium of the digital camera into its own storage portion, depending on whether or not the image file of the representative image is included in the image files stored in the folder in the storage portion, can make switching between the following two operations: displaying only the image of the folder and displaying the representative image in a manner superimposed on the image of the folder. The data that marks the representative image is recorded in the image file itself. Therefore, reading the image file automatically results in reading the data that marks the representative image. The user can recognize what images are contained in the image files stored in the folder, based on the representative image displayed superimposed on the image of the folder.

It may be checked in the first step whether or not data that marks a representative image is recorded in a tag of the image file. Recording the data marking the representative image eliminates the need to specially structure the image file.

If the number of image files containing data recorded to mark a representative image is equal to or less than a predetermined number, images of all these image files are displayed in the second step. The larger the number of representative images that are displayed, the easier it becomes to recognize what images are contained in the image files stored in the folder.

If the number of image files containing data recorded to mark a representative image exceeds a predetermined number, in the second step, of all images of these image files, only images of the predetermined number of image files are displayed while a number of remaining image files may be displayed along the image of the folder. If there are a great number of representative images, the representative images can no longer be displayed superimposed on the image of the folder all at once. Even in such a case, displaying the number of the representative images that are not displayed can notify the user that there exist representative images other than those being displayed. Moreover, the display can also be switched so that the images that are not displayed are displayed superimposed on the image of the folder.

In the case of a program that searches the recording medium, if, as the above-mentioned folder, a plurality of folders storing image files are created on the recording medium, images of the folders may be displayed side-by-side in the second step. This makes it possible to recognize which image is contained in the image file stored in which folder.

In the case of a program that reads image files from the recording medium into the storage portion of the personal computer, as the above-mentioned folder, a plurality of folders storing image files may be created in the storage portion, and images of the folders may be displayed side-by-side in the second step. Creating a plurality of folders allows easy classification and thus management of the acquired image files. Thus, displaying the images of the folders side-by-side and also displaying the representative images in a manner superimposed on the images of the folders that store the image files of the representative images allows recognition of which images are contained in the image files stored in which folders.

### BRIEF DESCRIPTION OF THE DRAWINGS

FIGS. 1A and 1B are a perspective view and a back view, respectively, schematically showing the external appearance of a digital camera according to a first embodiment of the invention;

FIG. 2 is a schematic diagram showing the configuration of the digital camera;

FIG. 3 is a schematic diagram showing the folder configuration of a memory card on which the digital camera records image files;

FIG. 4 is a flow chart showing the flow of operations performed by the digital camera in a normal photographing mode;

FIGS. 5A to 5C show examples of screens displayed by the digital camera to permit the setting of a representative image in response to an instruction given by the user;

FIG. 6 is a flow chart showing the flow of operations for setting a representative image in response to an instruction given by the user;

FIGS. 7A to 7D show examples of screens displayed by the digital camera in an annotation photographing mode;

FIG. 8 is a flow chart showing the flow of operations performed by the digital camera in the annotation photographing mode;

FIGS. 9A and 9B show examples of screens displayed by the digital camera in a guide photographing mode;

FIG. 10 is a flow chart showing the flow of operations performed by the digital camera in the guide photographing mode;

FIGS. 11A to 11C show examples of screens displayed by the digital camera in a playback mode;

FIG. 12 is a flow chart showing the flow of operations performed by the digital camera in the playback mode;

FIG. 13 is a schematic diagram showing the external appearance of a personal computer according to a second embodiment of the invention;

FIG. 14 is a schematic diagram showing the configuration of the personal computer.

FIG. 15 shows a search screen displayed by the personal computer;

FIGS. 16A and 16B show examples of images displayed by the personal computer in a folder and file display region on the search screen;

FIG. 17 shows an example of the content of a folder searched by the personal computer;

FIG. 18 is a flow chart showing the flow of operations performed by the personal computer to search a memory card;

FIG. 19 is a flow chart showing the flow of operations performed by the personal computer to read an image file;

FIG. 20 is a flow chart showing the flow of operations performed by the personal computer to display an image;

FIG. 21 shows a screen displayed by the personal computer to permit the setting of a representative image;

FIG. 22 shows a screen displayed by the personal computer to permit the selection of a file name; and

FIG. 23 is a flow chart showing the flow of operations performed by the personal computer to set a representative image.

### DETAILED DESCRIPTION OF PREFERRED EMBODIMENTS

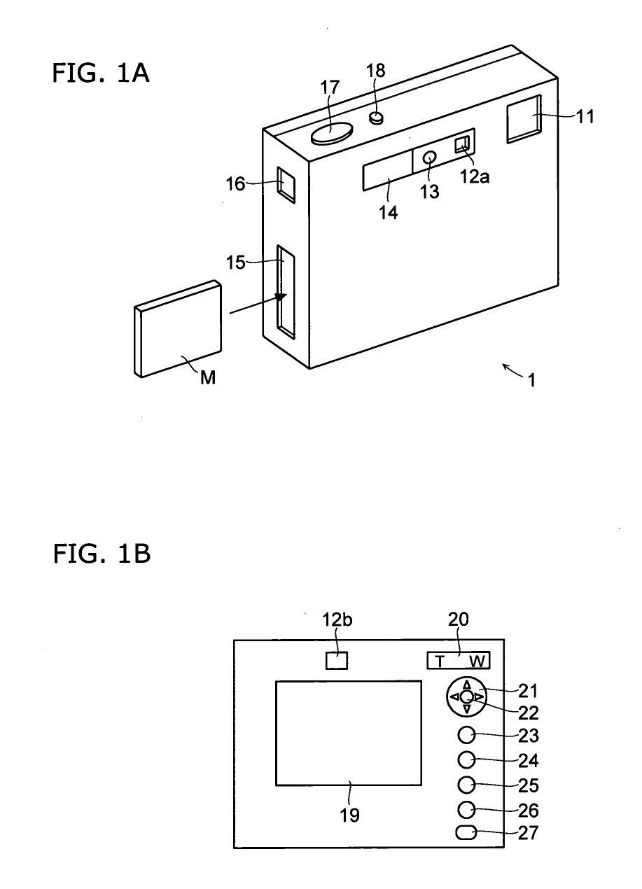

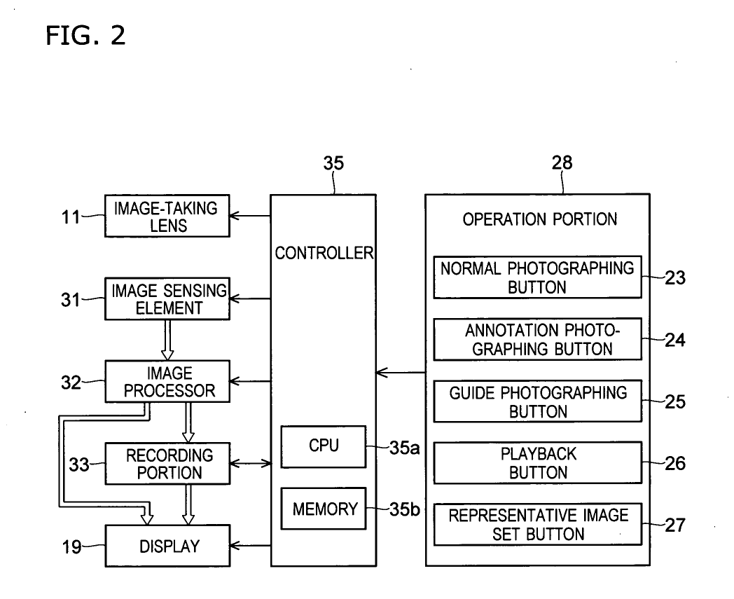

The embodiments of the present invention will be described hereinafter with reference to the accompanying drawings. FIGS. 1A and 1B are schematic diagrams showing the external view of a digital camera 1 according to a first embodiment of the invention. FIG. 1A is a perspective view as viewed obliquely from the front. FIG. 1B is a back view. The digital camera 1 includes on the front surface thereof: an image-taking lens 11 for directing light from a photographing subject to a built-in image-sensing element (see FIG. 2); an optical viewfinder front window 12a; a self timer lamp 13; and a flash emitter 14. The digital camera 1 includes on the side surface thereof: a card slot 15 into which a memory card M as a removable recording medium is inserted, and a USB/AV output terminal 16. Moreover, the digital camera 1 includes on the top surface thereof a shutter release button 17 and a power button 18. The digital camera 1 includes on the rear surface an optical finder rear window 12b and a display 19 built with a liquid crystal panel. The image-taking lens 11 is a zoom lens.

The digital camera 1 can, while photographing an image, immediately display the photographed image on the display 19 to provide a live view thereof. Thus, the display 19 functions as a viewfinder. The image photographed immediately after the release button 17 is operated is recorded as an image file onto the removable memory card M that incorporates semiconductor memory. The image is displayed as an after view on the display 19 for a short period of time. The image of the image file recorded on the memory card M can also be played back to be displayed on the display 19. Photographing-related data such as the photographing date and time, the image scale, the exposure conditions, and the photographing mode is recorded in the tag (header) of the image file recorded on the memory card M.

The digital camera 1 operates in, other than a normal photographing mode for performing normal photographing, an annotation photographing mode and a guide photographing mode. The annotation photographing mode is for adding an image as an annotation to a partial region of an already photographed image whose image file has been recorded onto the memory card M. The image photographed immediately after the region is specified becomes the annotation for the region. The guide photographing mode is provided for, in an image photographing operation, displaying on the display 19 an already photographed image whose image file has been recorded onto the memory card M so that the image serves as a reference for photographing a new image.

In the annotation photographing mode, an image whose image file is written onto the memory card M by an external device, e.g., an image whose image file is read from an original document with an image scanner so as to be recorded onto the memory card M, can be treated as an image to which to add an annotation. Similarly, in the guide photographing mode, an image whose image file is written onto the memory card M with an external device can be treated as an image to be displayed as a reference.

The digital camera 1 includes, on the rear surface thereof, a normal photographing button 23, an annotation photographing button 24, and a guide photographing button 25 for specifying these three modes. The digital camera 1 also includes: a zoom button 20 for specifying the focal length of the image-taking lens 11 which is a zoom lens; direction buttons 21 that are used for selecting an item displayed on the display 19; a confirm button 22 for giving an instruction for confirming the selection; and a playback button 26 for specifying a playback mode for playing back an image for display. The direction buttons 21 include an up button, a down button, a left button, and a right button for specifying the up, down, left, and right directions, respectively.

As described above, the digital camera 1 records image files onto the memory card M. Folders are created on the memory card M so that the image files are stored in the folders. The folders can be freely created by the user. The user specifies a desired folder from among the folders already created. New image files are recorded in the specified folder until another folder is specified.

The image files no longer needed can be deleted individually or collectively from the memory card M. Deleting a folder allows deletion of all the image files stored therein.

The digital camera 1 is capable of determining a representative image that represents all the images of the image files stored in each folder. The user can specify a desired image as a representative image among images photographed in the normal photographing mode. There is no restriction on the number of representative images that can be specified by the user. The digital camera 1 includes on the back surface thereof a representative image set button 27 that is used for setting a representative image.

When an image is photographed as an annotation in the annotation photographing mode, the digital camera 1 specifies, as a representative image, the image to which the annotation is added. When an image is photographed in the guide photographing mode, the digital camera 1 specifies, as a representative image, the image used as a reference in this operation.

Data that marks a representative image is recorded in the tag of the image file of the representative image. Generally, a file has a tag for recording data related thereto. Using the tag for recording the data that marks a representative image eliminates the need to specially structure the image file. Alternatively, data that marks a representative image may be stored in a special file created in the same folder that stores the representative image, though recording such data in the image file itself makes file management easier.

Association data indicating the association between an image photographed as an annotation in the annotation photographing mode and the image and the region to which the annotation is added is also recorded in the tag of the image file. The association data is recorded in the image files of both the image photographed as the annotation and the image (referred to as a parent image) to which the annotation is added. Association data indicating the association between an image photographed in the guide photographing mode and the image (referred to as a guide image) used as a reference in this photographing operation is also recorded in the tag of the image file. This association data is also recorded in the image files of both the images.

An image used as a parent image in the annotation photographing mode and an image used as a guide image in the guide photographing mode are selected by the user from among the images of the image files stored in the folder which has been specified for storing the image files of newly photographed images. Therefore, the image file of an image photographed in the annotation photographing mode and the image file of an image photographed in the guide photographing mode are stored in the same folder that stores the parent image and the guide image, respectively.

FIG. 2 is a schematic diagram showing the configuration of the digital camera 1. In addition to the above-mentioned image-taking lens 11, display 19, etc., the digital camera 1 includes an image sensing element 31, an image processor 32, a recording portion 33, and a controller 35. The image sensing element 31 photographs an image by converting the light directed thereto by the image-taking lens 11 into an electrical signal. The image processor 32 processes the signal outputted by the image sensing element 31 to thereby create recording image data representing the photographed image and image data for display. The recording image data is compressed. The recording portion 33 records an image file onto the memory card M as image data, and also reads out the image file from the memory card M so as to play back the image for display.

The controller 35 includes a CPU 35a and a memory 35b. The CPU 35a controls various portions of the digital camera 1. A program containing instructions for control operations to be performed by the CPU 35a is recorded in the memory 35b. The CPU 35a also performs processing of representative images based on the program recorded in the memory 35b.

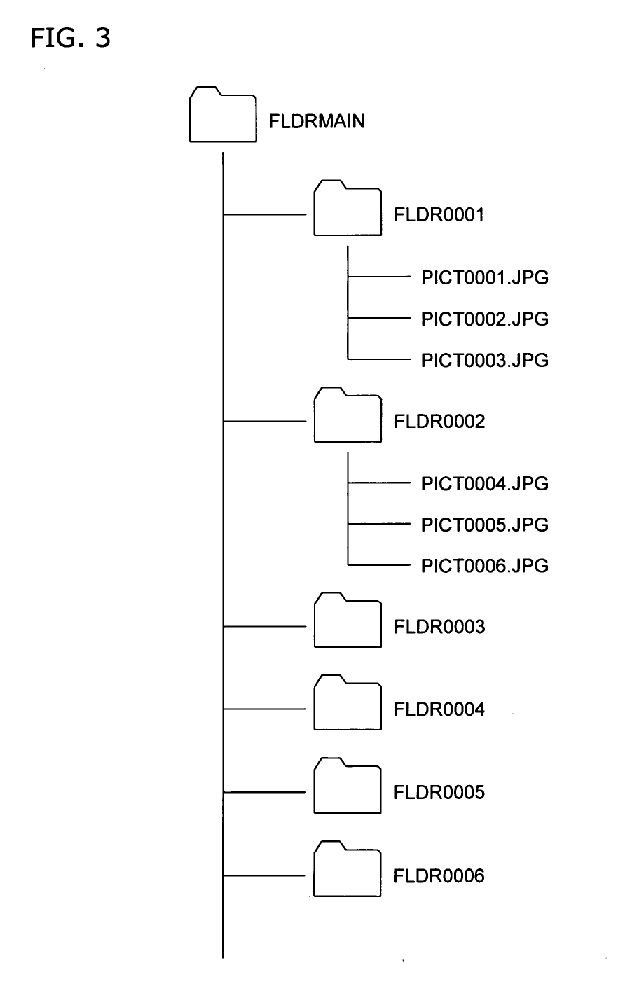

The operation members such as the above-mentioned shutter release button 17 and power button 18 are collectively referred to as an operation portion 28. FIG. 2 shows only the operation members concerned with representative images.
FIG. 3 is a schematic diagram showing the folder structure on the memory card M. In the folder named “FLDRMAIN”, the folders (folders named “FLDR0001” to “FLDR0006”) are created for recording the image files. The image files (files named “PICT0001.JPG” to “PICT0006.JPG”) are stored in two of the folders.

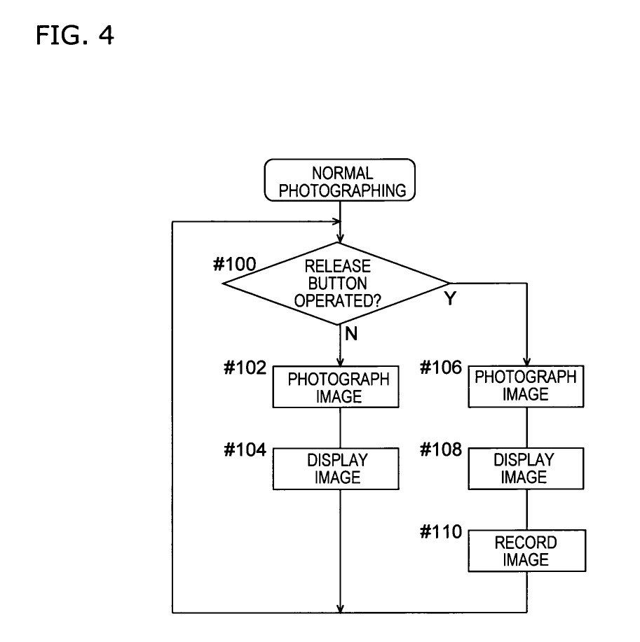

FIG. 4 shows the flow of operations performed to photograph an image in the normal photographing mode and then record the image file of the photographed image. This sequence of operations starts when the normal photographing button 23 is operated. First, it is checked whether or not the shutter release button 17 is operated to enter an instruction for photographing a recording image (step #100). If the instruction is not entered, an image is sensed (#102), and the sensed image is displayed on the display 19 (#104). Then the flow returns to step #102. A live view is provided by repeating steps #102 and #104.

If the instruction for photographing the recording image is provided, the image is sensed (#106), the sensed image is displayed (#108), and then the image file of the sensed image is recorded onto the memory card M (#110). An after view is provided by continuously displaying the image for a short period of time in step #108. The flow in FIG. 3 continues until the working mode is switched to the playback mode or another photographing mode.

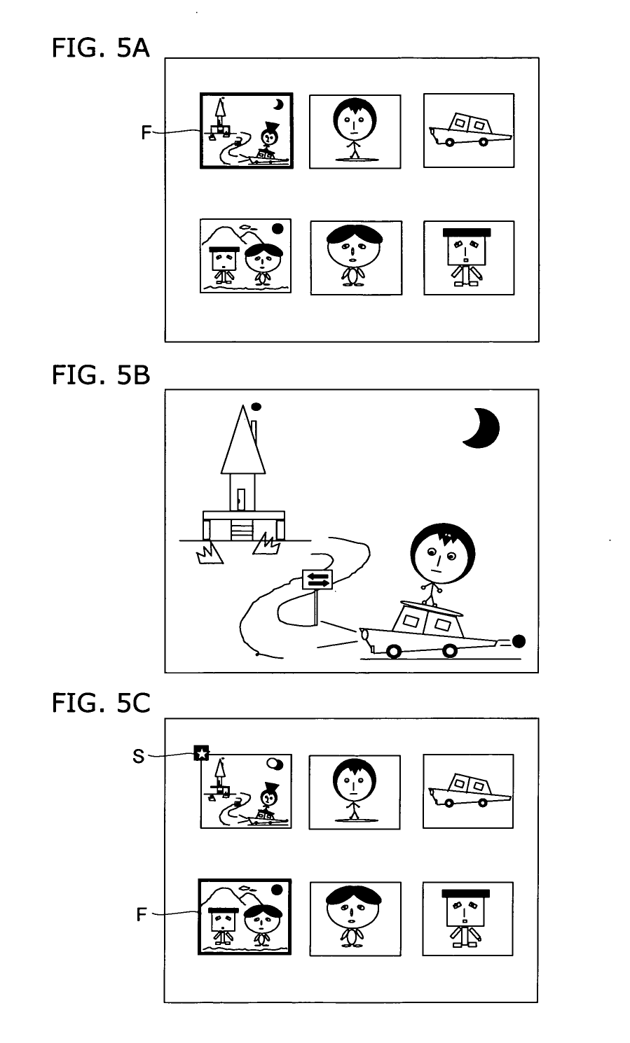

FIGS. 5A to 5C show examples of screens displayed on the display 19 when the user specifies a representative image among images photographed in the normal photographing mode. FIG. 5A is the screen displayed when the representative image set button 27 is operated. On this screen, all the images stored in the folder that is set at this point as a folder for storing the image files are displayed side-by-side on a reduced scale. The user can operate the direction buttons 21 to select an image and operate the confirm button 22 to specify the selected image as a representative image. A frame F is displayed around the selected image to indicate that the image is being selected. In order to indicate that images photographed in the annotation photographing mode and the guide photographing mode cannot be specified as representative images, they are displayed in a different mode of display from the images photographed in the normal photographing mode.

FIG. 5B is the screen displayed when the representative image has been specified through the operation of the confirm button 22. The specified representative image is displayed on this screen. The screen is continuously displayed for a short period of time (several seconds).

FIG. 5C is the screen displayed after the screen of FIG. 5B is displayed. The images are displayed side-by-side in the folder in a similar manner to FIG. 5A. The image specified as a representative image is marked with a symbol S that indicates a representative image.

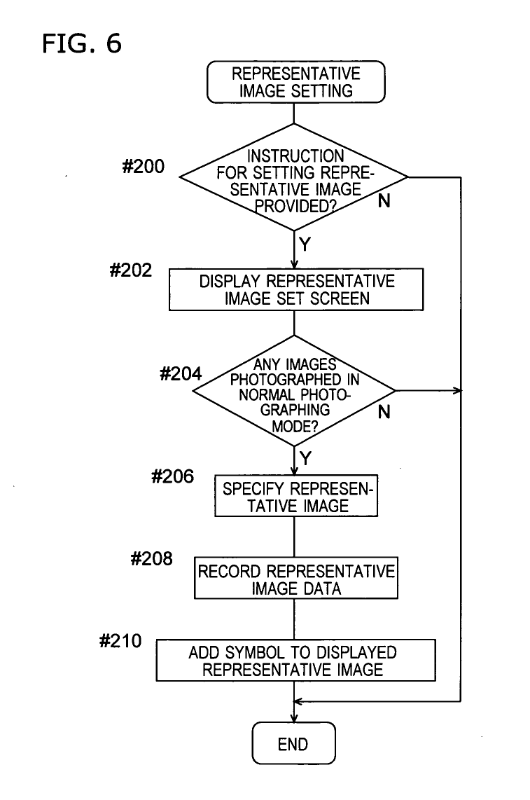

FIG. 6 shows the flow of operations performed to set a representative image in response to an instruction given by the user. First, the representative image set button 27 is operated to check whether or not an instruction for setting a representative image is entered (step #200). If the instruction is not entered, the sequence of operations ends. If the instruction is entered, the screen displayed in FIG. 5A for specifying a representative image is displayed (#202). Then, it is checked whether or not the image files of the images photographed in the normal photographing mode are included in the folder (#204). If no such image files are included in the folder, the sequence of operations ends.

If one or more image files of the images photographed in the normal photographing mode are included in the folder, the specification of a representative image through the operation of the direction buttons 21 and the confirm button 22 is accepted (#206). Then data that marks a representative image is recorded in the tag of the image file of the image specified as a representative image (#208). After the image is displayed on an enlarged scale for a short period of time as in FIG. 5B, the display is switched back to the original state as indicated in FIG. 5C. Then the symbol S indicating a representative image is added to the image specified as the representative image (#210), thereby ending the sequence of operations.

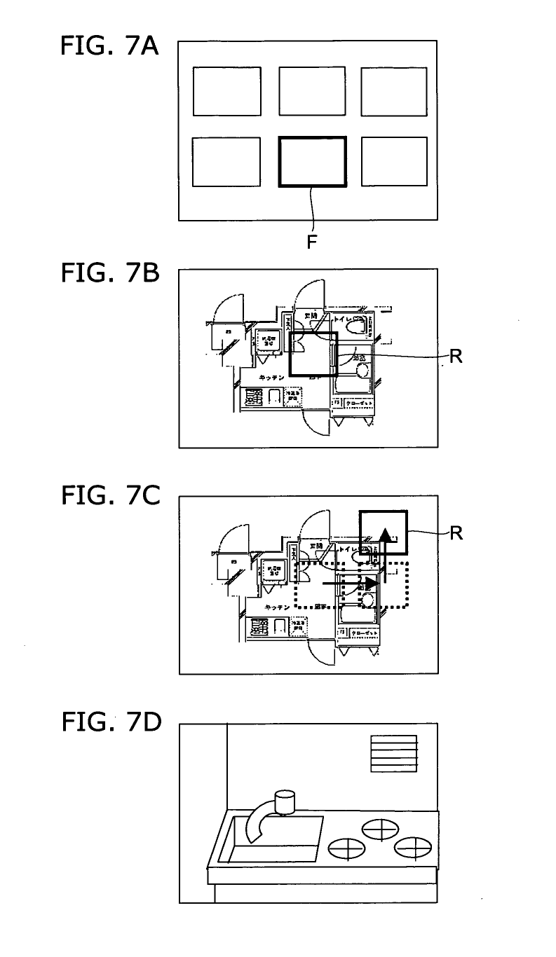

FIGS. 7A to 7D show examples of screens displayed on the display 19 in the annotation photographing mode. FIG. 7A is the screen displayed when the annotation photographing button 24 is operated. On this screen, all images stored in the folder that is set at this point as a folder storing image files are displayed side-by-side on a reduced scale. The user can operate the direction buttons 21 to select an image and operate the confirm button 22 to specify the selected image as a parent image. A frame F is displayed around the selected image to indicate that the image is being selected.

FIG. 7B is the screen displayed when the parent image has been specified through the operation of the confirm button 22. This screen displays the specified parent image, on which a frame R indicating a region to which to add an annotation is displayed superimposed. The region to which to add an annotation is set in a predetermined size at the center of the parent image. The user can operate the direction buttons 21 and the confirm button 22 to freely change the size and the location of the region to which to add an annotation. FIG. 7C shows how this is performed/achieved.

FIG. 7D is the screen displayed when the shutter release button 17 is operated after a parent image and a region thereon have been specified. This screen displays a recording image photographed in response to the operation of the shutter release button 17, i.e., the after view of the image to be used as an annotation for the parent image.

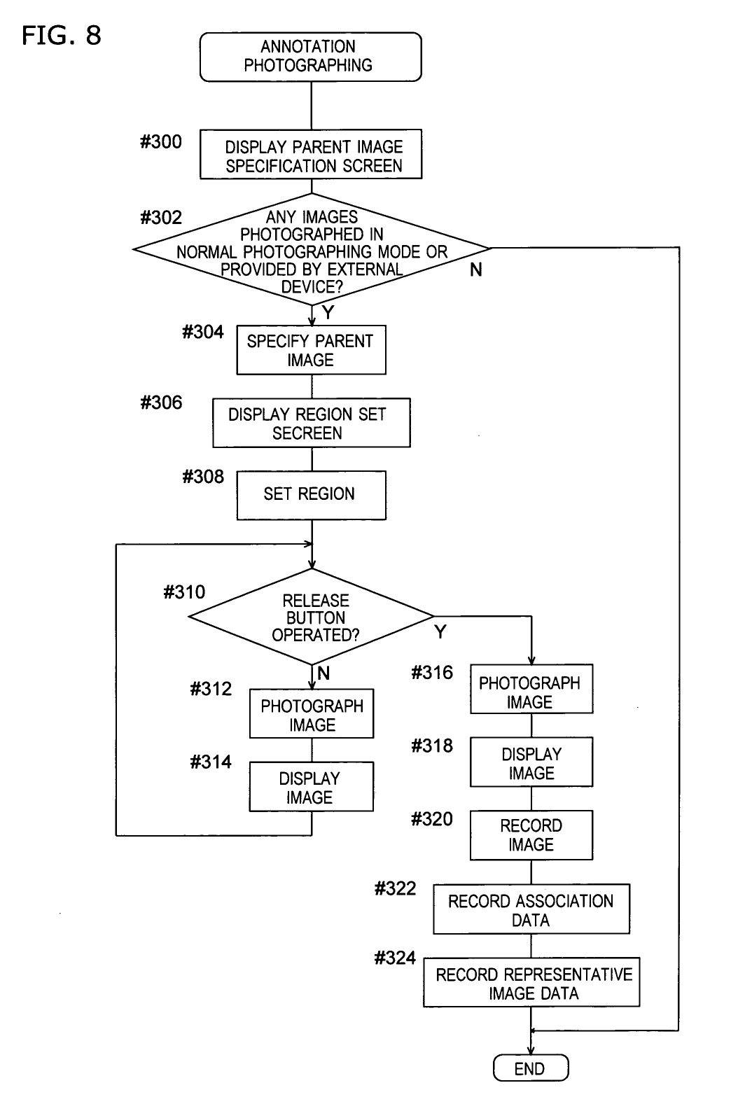

FIG. 8 shows the flow of operations performed in the annotation photographing mode. This sequence of operations starts when the annotation photographing button 24 is operated. First, the screen shown in FIG. 7A for specifying a parent image is displayed (step #300). Then, it is checked whether or not the image files of images photographed in the normal photographing mode or image files recorded with an external device are included in the folder (#302). If no such image files are included in the folder, the sequence of the operations ends.

If the image file of an image photographed in the normal photographing mode or an image file recorded with the external device is included in the folder, the specification of the parent image through the operation of the direction buttons 21 and the confirm button 22 is accepted (#304). Then, the screens shown in FIGS. 7B and 7C for setting the region is displayed (#306), and then the setting of the region through the operation of the direction buttons 21 and the confirm button 22 is accepted (#308).

Subsequently, it is checked whether or not an instruction for photographing a recording image is entered through the operation of the shutter release button 17 (step #310). If the instruction is not entered, an image is sensed (# 312), and the sensed image is displayed on the display 19 (#314). Then the flow returns to step #310. A live view is provided by repeating steps #312 and #314.

If the instruction for photographing a recording image is provided, an image is sensed (#316), the sensed image is displayed (#318), and then the image file of the sensed image is recorded onto the memory card M (#320). Further, association data indicating that the photographed image is an annotation added to a partial region of the parent image is recorded in the tags of the image files of the photographed image and the parent image (#322). Then, data that marks a representative image is recorded in the tag of the image file of the parent image (#324), thereby ending the sequence of operations. Maintaining the screen displayed in step #318 for a short period of time provides an after view as shown in FIG. 7C.

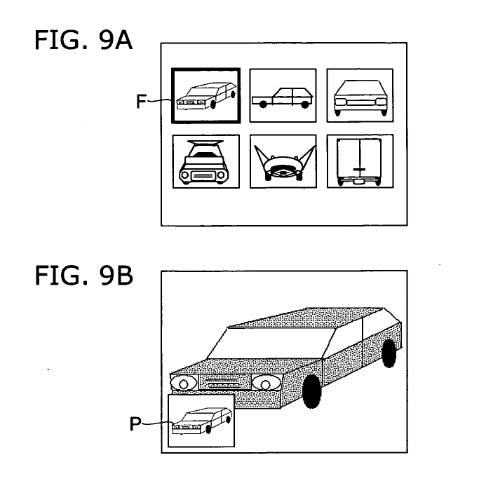

FIGS. 9A and 9B show examples of screens displayed on the display 19 in the guide photographing mode. FIG. 9A is the screen displayed when the guide photographing button 25 is operated. On this screen, all the images stored in the folder that is set at this point as a folder storing the image files are displayed side-by-side on a reduced scale. The user can operate the direction buttons 21 to select an image and operate the confirm button 22 to specify the selected image as a guide image. A frame F is displayed around the selected image for indicating that the image is being selected.

FIG. 9B is the screen displayed after the guide image is specified. On this screen, the reduced guide image is displayed superimposed on the live view. The user can specify the composition, etc. of a new image to be photographed while viewing the guide image.

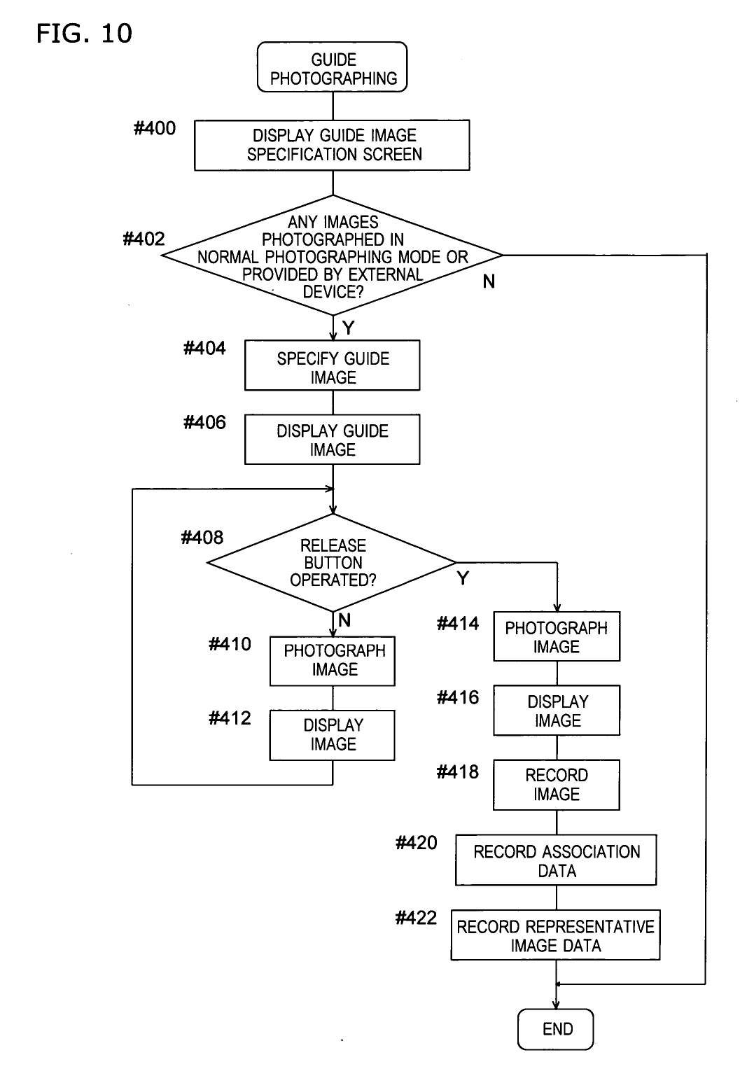

FIG. 10 shows the flow of operations performed in the guide photographing mode. This sequence of operations starts when the guide photographing button 25 is operated. First, the screen shown in FIG. 9A for specifying a guide image is displayed (step #400). Then, it is checked whether or not the image files of images photographed in the normal photographing mode or image files recorded with an external device are included in the folder (#402). If no such image files are included in the folder, the sequence of operations ends.

If the image file of an image photographed in the normal photographing mode or an image file recorded with the external device is included in the folder, the specification of the guide image through the operation of the direction button 21 and the confirm button 22 is accepted (#404). Then, the specified guide image is displayed on a reduced scale (#406).

Subsequently, it is checked whether or not an instruction for photographing a recording image is entered through the operation of the shutter release button 17 (#408). If the instruction is not entered, an image is sensed (#410), the sensed image is displayed on the display 19 (#412), and the flow returns to step #408. Steps #410 and #412 are repeated to provide a live view, on a partial region of which the guide image is superimposed.

If the instruction for photographing a recording image is entered, an image is sensed (#414), the sensed image is displayed (#416), and then the image file of the sensed image is recorded onto the memory card M (#418). Further, association data indicating that the photographed image is obtained by referring to the guide image is recorded in the tags of the image files of the photographed image and the guide image (#420). Then, data that marks a representative image is recorded in the tag of the image file of the guide image (#422), thereby ending the sequence of operations. Maintaining the screen displayed in step #416 for a short period of time provides an after view, thereby allowing the checking of whether or not the after view is similar to the guide image on which the after view is displayed superimposed.

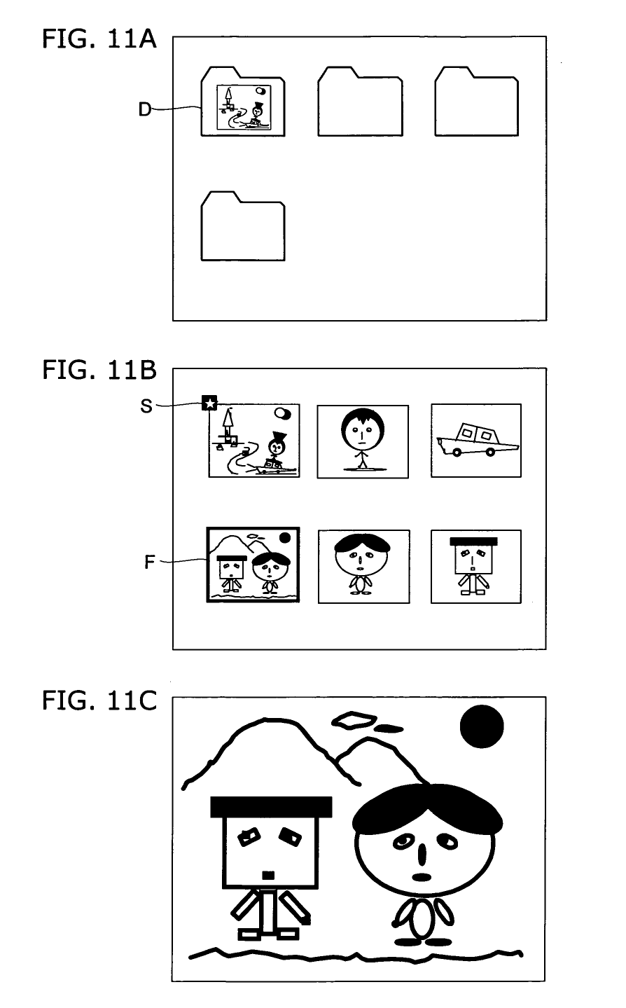

FIGS. 11A to 11C show examples of screens displayed on the display 19 in the playback mode for playing back images for display. FIG. 11A is the screen displayed when the playback button 26 is operated. On this screen, all the images D of the folders created on the recording medium for storing the image files are displayed side-by-side. Moreover, a representative image is superimposed on the image of the folder storing the image file of the representative image. The user can operate the direction buttons 21 and the confirm button 22 to specify a desired folder.

FIG. 11B is the screen displayed after the folder is specified. On this screen, all the images stored in the folder are displayed side-by-side on a reduced scale. The representative image is marked with the aforementioned symbol S marking a representative image. The user can operate the direction buttons 21 to select an image and operate the confirm button 22 to specify the selected image as an image to be displayed. A frame F is displayed around the selected image to indicate that the image is being selected. FIG. 11C is the screen displaying the specified image.

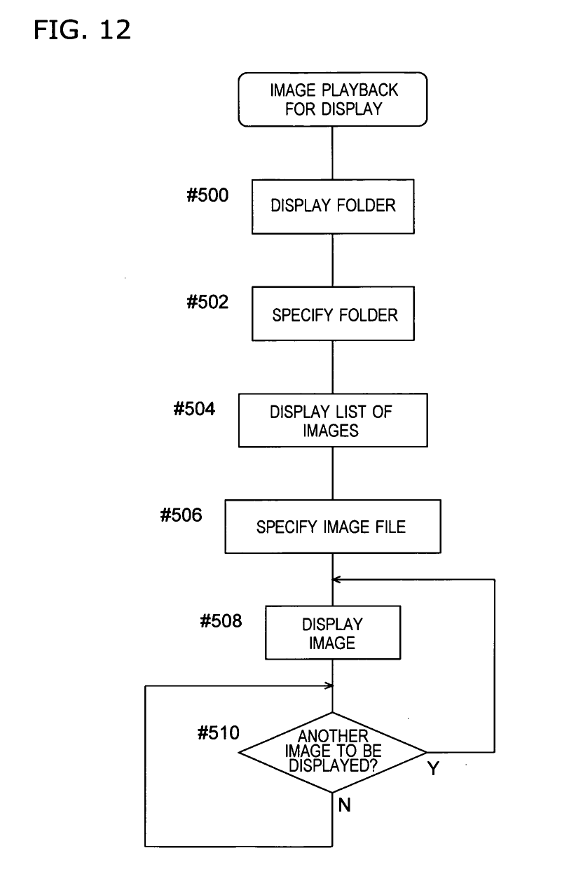

FIG. 12 shows the flow of operations performed in the playback mode. This sequence of operations starts when the playback button 26 is operated. First, the screen shown in FIG. 11A for specifying a folder is displayed (step #500). Subsequently, the specification of the folder is accepted (#502), and the screen shown in FIG. 11B for specifying an image is displayed (#504). The specification of the image is accepted (#506), and the specified image is displayed as shown in FIG. 11C (#508). Subsequently, an instruction on whether or not to display another image is accepted (#510). The flow returns to step #508 if the instruction for displaying another image is entered. If the instruction is not entered, the instruction is awaited.

The instruction for displaying another image is entered through the operation of the direction buttons 21. Of the direction buttons 21, the right button is used to specify the image located immediately after the image displayed in step #508, and the left button is used to specify the image located immediately before the image displayed in step #508. The branching from step #510 to #508 in FIG. 12 is performed when these buttons are operated. Of the direction buttons 21, the up button is used to enter an instruction to display the screen for specifying a folder while the down button is used for providing an instruction to display the screen for specifying an image. When these buttons are operated, the flow returns to step #500 and step #504, respectively. The playback mode is ended by switching to any of the photographing modes.

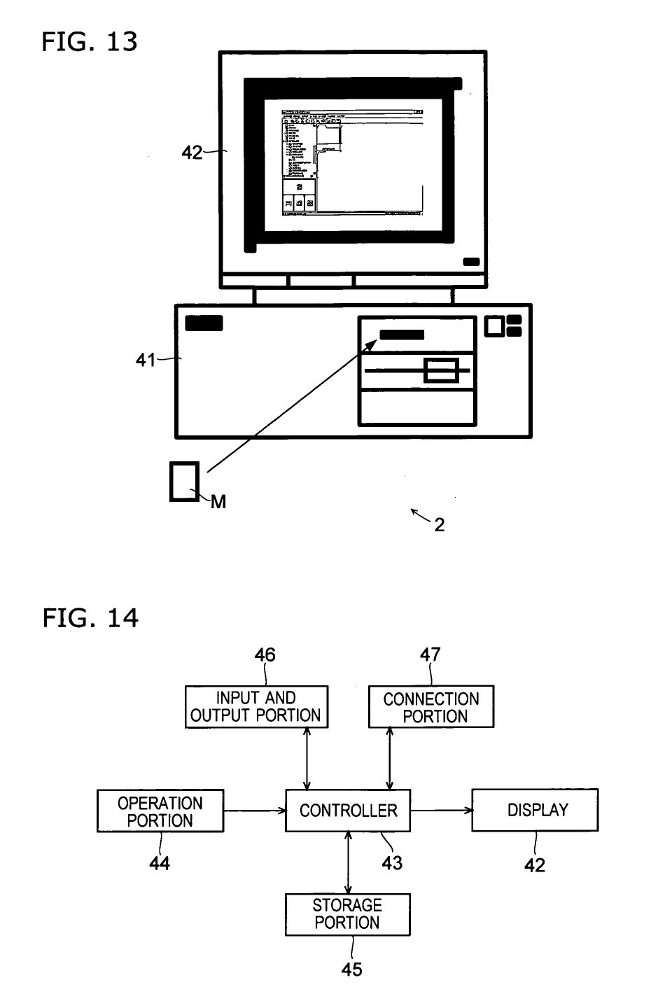

FIG. 13 is a schematic diagram showing the external view of a personal computer 2 according to a second embodiment of the invention. The personal computer 2 includes: a main body 41 provided with a CPU for performing various operations, a memory for storing data, and a built-in recording medium such as a hard disk; and a display 42 for displaying various kinds of data such as images and characters. The main body 41 is provided with a card slot into which a removable memory card M can be inserted. Moreover, although not illustrated, the main body 41 is connected with a keyboard and a mouse used for input operations.

FIG. 14 is a schematic diagram showing the configuration of the personal computer 2. The personal computer 2 has: a controller 43 including the CPU; an operation portion 44 including the mouse and the keyboard; a storage portion 45 including the recording medium such as a semiconductor memory and a hard disk; an input and output portion 46 for performing input and output operations on the memory card M; and a connection portion 47 for achieving a connection with an external device via a cable. The storage portion 45 stores a program containing instructions for the control performed by the personal computer 2 and also a program containing instructions for image processing performed by the personal computer 2. The CPU of the controller 43 performs the necessary operations in accordance with these programs. The storage portion 45 also stores images. The images stored in the storage portion 45 are fed from the digital camera 1 of the first embodiment via the cable or read out from the memory card M used for the digital camera.

The personal computer 2 is capable of searching the memory card M inserted in the digital camera 1 that is connected to the personal computer 2 via the cable and also the memory card M inserted in the card slot of the personal computer 2 itself so as to identify what folders and what image files are stored on these memory cards M. The personal computer 2 is also capable of reading an image file from the memory card M to store it in the storage portion 45. The image file stored in the storage portion 45 can be displayed on the display 42 and edited.

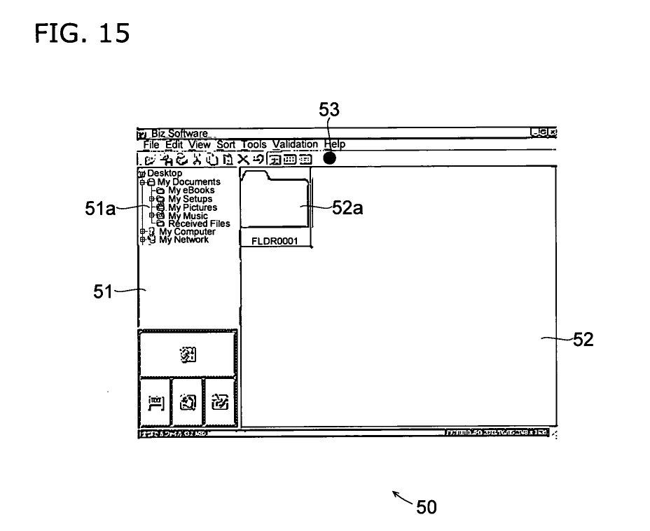

FIG. 15 shows a search screen 50 displayed on the display 42 by the personal computer 2 to carry out a search for a folder and an image file stored on the memory card M. The search screen 50 is displayed not only for searching the memory card M but also for searching for a folder and a file stored in the storage portion 45. The search screen 50 includes a tree display region 51 and a folder and file display region 52. The tree display region 51 displays a folder tree 51a which indicates the relationship between a device and folders in a tree structure. The folder and file display region 52 displays a folder 52a and files included in the specified device or folder in the folder tree 51a. On the search screen 50, a representative image specify button 53 is displayed for displaying a dialog box for specifying a representative image.

When the user operates the mouse or the keys on the keyboard to specify a device or a folder in the folder tree 51a displayed in the tree display region 51, or the folder 52a displayed in the folder and file display region 52, the images and names of the folders and files stored in the specified device or folder are displayed in the folder and file display region 52.

For example, in a case where the memory card M of the digital camera 1 has a folder structure as shown in FIG. 3, when the user specifies the memory card M as a device, the folder “FLDRMAIN” is displayed in the folder and file display region 52, and the name of this folder is also displayed in the folder tree 51a. Further, when this folder is specified, the folders such as “FLDR0001” included therein are displayed in the folder and file display region 52, and the names of the folders are also displayed in the folder tree 51a.

When any of the image files stored in the image folder includes data that marks a representative image, the image of the representative image is displayed superimposed on the image of the folder. When a plurality of representative images are specified for one folder, the plurality of representative images are displayed side-by-side on the image of the folder. However, displaying many images on the image of one folder results in very small images, which makes it difficult to recognize the contents thereof. Thus, an upper limit is set on the number (e.g. 4) of representative images to be displayed side-by-side on the image of one folder. A predetermine number of representative images are thus displayed, while only the number of representative images that are not displayed is displayed along the image of the folder.

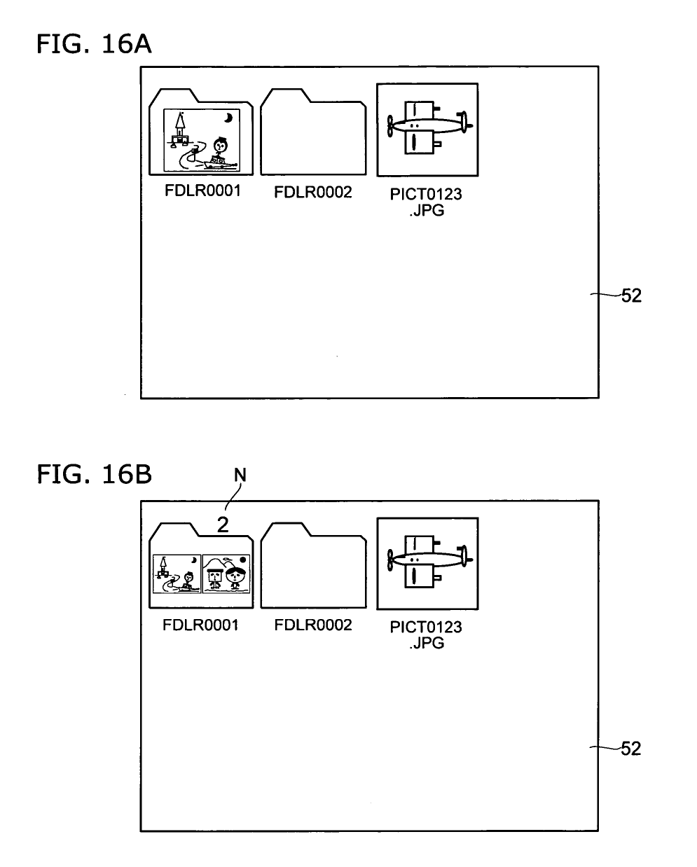

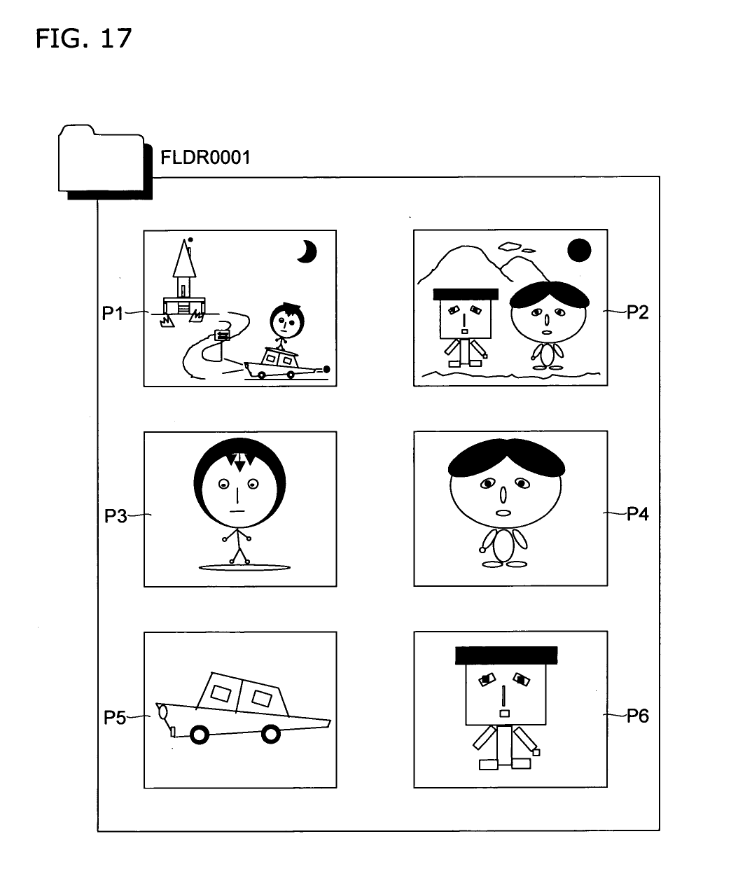

Suppose that, as shown in FIG. 17, image files P1 to P6 are stored in the folder “FLDR0001”. In this case, for example, screens as shown in FIGS. 16A and 16B are displayed in the folder and file display region 52. FIG. 16A shows a case where only the image of the image file P1 is set as a representative image, in which case only the image P1 is displayed superimposed on the image of the folder “FLDR0001”. FIG. 16B shows a case where the images of the four image files P1, P2, P4, and P6 are set as representative images, and in addition the upper limit on the number of representative images to be displayed is set at 2. In this case, on the image of the folder “FLDR0001”, the images P1 and P2 are displayed side-by-side, while the number N, which represents the number of remaining representative images that are not displayed, is displayed by the side of the image of the folder.

The order in which representative images are displayed is determined in accordance with the dates and times of creation of the image files of the representative images, but this order can be changed by the user. As in FIG. 16B, even some representative images that remain undisplayed can be displayed by changing the order of display.

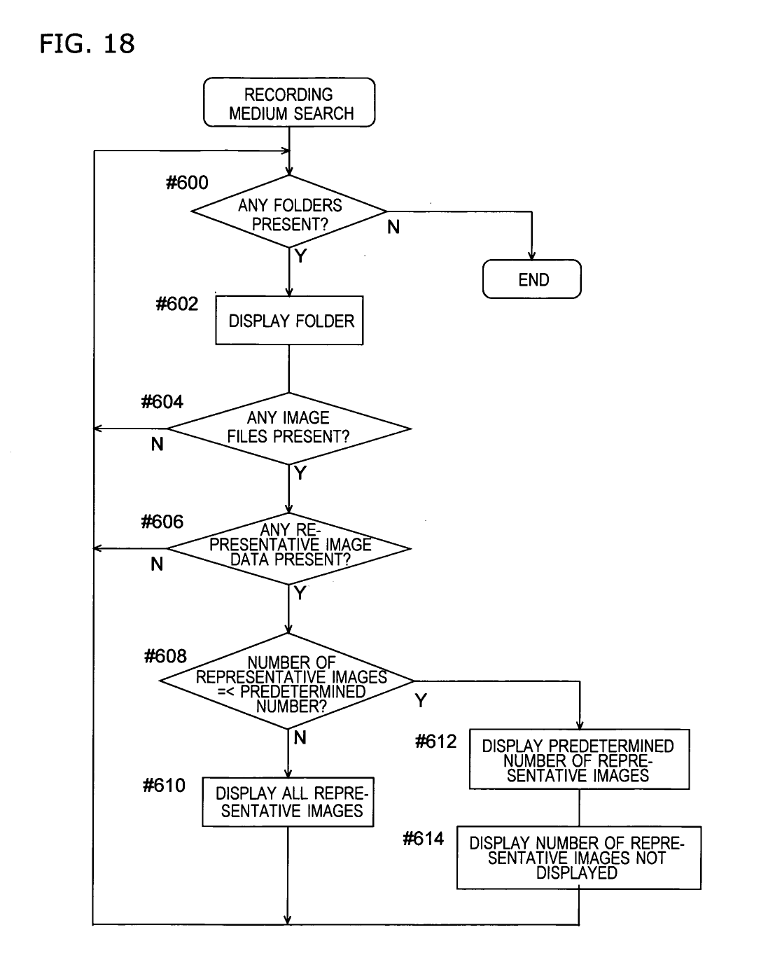

FIG. 18 shows the flow of operations performed to search the memory card M. First, it is checked whether or not folders are included in the specified device or folder (step #600). If no folder is included therein, the sequence of operations ends. If one or more folders are included in the specified device or folder, the image and the name of one of the folders included are displayed in the folder and file display region 52 (#602). Subsequently, it is checked whether or not image files are stored in the folder (#604). If no image files are stored therein, the flow returns to step #600 to perform the operations in steps #600 and #602 for the next folder.

If one or more image files are stored in the folder, the data recorded in the tag of each image file is read to check whether or not data that marks a representative image is included therein (#606). If no data that marks a representative image is included therein, the flow returns to step #600. If data that marks a representative image is included in the tag of any of the image files, it is checked whether or not the number of image files including this data, i.e., the number of representative images, is equal to or less than a predetermined number (#608).

When the number of representative images is equal to or less than the predetermined number, all the representative images are displayed superimposed on the image of the folder displayed in step #602 (#610). Then, the flow returns to step #600. When the number of representative images exceeds the predetermined number, the predetermined number of representative images are superimposed on the image of the folder (#612), while only the number of representative images that are not displayed is displayed together (#604). Then, the sequence of the operations returns to step #600.

While the search screen 50 (FIG. 15) is displayed, the user can display on the display 42 the image contained in an image file stored in a folder on the memory card M, and also can read an image file from a folder on the memory card M to store it in the storage portion 45. Moreover, the user can display on the display 42 the image of an image file read from a folder on the image card M and then stored in the storage portion 45.

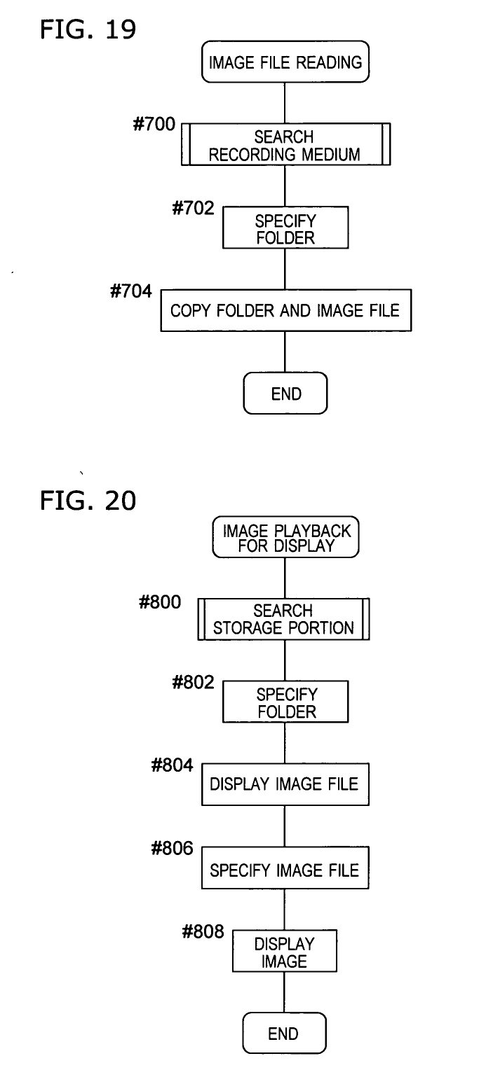

FIG. 19 shows the flow of operations performed to read an image from the memory card M to store the image in the storage portion 45. First, the operation for searching the memory card M shown in FIG. 18 is performed (step #700). Then, while folders are displayed in the folder and file display region 52, the folder specification made by the user is accepted (#702). Then all the image files stored in the specified folder are copied onto the recording medium of the storage portion 45 (#704). In this operation, a folder is created that has the same name as that of the folder from which the image files are read, so that the read image files are stored in the created folder. The folder is specified through the operation of the mouse or the keyboard. The names of the read image files and the name of the folder that stores the image files can be changed on the search screen.

In the operations of FIG. 19, the image files are read folder by folder. Alternatively, the image files may be read individually in the following manner. All the image files stored in the folder are displayed when the folder is specified in step #702. After accepting the image file specification, the specified image file is copied into the storage portion 45. In this case, a new folder may be created as described above so that the image file is stored therein, or the image file can be stored in an existing folder.

FIG. 20 shows the flow of operations performed to display the image of an image file stored in the storage portion 45. First, the operation for searching the storage portion 45 is performed (step #800). This operation is similar to the operation for searching the memory card M shown in FIG. 18. Subsequently, the folder specification made by the user is accepted while the folder is being displayed in the folder and file display region 52 (#802), and the images and the names of all the images files stored in the specified folder are displayed side-by-side in the folder and file display region 52 (#804). The image file specification is then accepted (#806), and the image of the specified image file is displayed on the display 42 (#808), thereby ending the sequence of operation. In step #806, the image is displayed on a display screen which is different from the search screen 50.

The operations for directly displaying the image of an image file stored on the memory card M is also almost the same as the operations shown in FIG. 20. The only difference is that the memory card M is searched in step “#800.

New representative images can be set and existing representative images can be changed on the personal computer 2. The dialog box for specifying a representative image is displayed for this operation. As described above, the dialog box for specifying a representative image is displayed through the operation of the representative image specify button 53 displayed on the search screen 50.

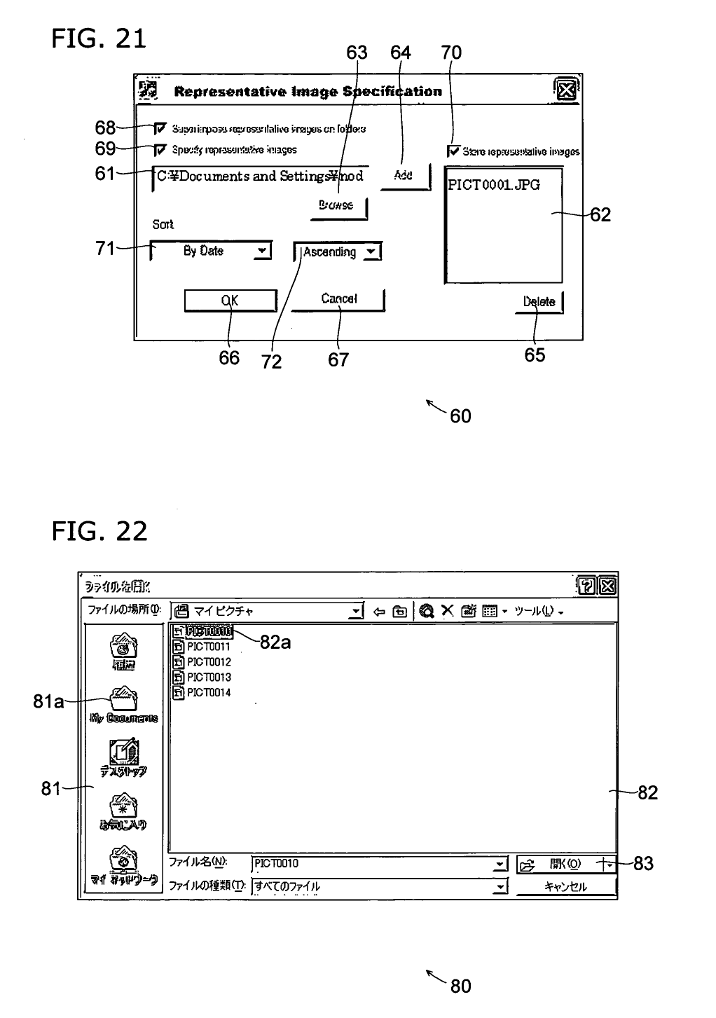

FIG. 21 shows a representative image specification dialog box 60. The representative image specification dialog box 60 includes a directory path display region 61 and a representative image file name display region 62. The representative image file name display region 62 displays the file name of an image specified as a representative image, and the directory path display region 61 displays the directory path to that image file.

The representative image specification dialog box 60 displays a browse button 63, an add button 64, a delete button 65, an OK button 66, a cancel button 67, a representative image display check box 68, a file display check box 69, a representative image storage check box 70, a sort method selection region 71, and a sort direction selection region 72. The browse button 63 is operated to display a dialog box that permits the selection of the file name of an image as a representative image. FIG. 22 shows a file name selection dialog box 80 displayed when the browse button 63 is operated.

The file name selection dialog box 80 includes a folder display region 81 for displaying a folder 81a, and a file name display region 82 for displaying a file name 82a of a file included in a folder selected in the folder display region 81. The file name selection dialog box 80 also includes an open button 83. A representative image can be specified by selecting (clicking) a file name displayed in the file name display region 82 and then operating the open button 83.

The add button 64 included in the representative image specification dialog box 60 (FIG. 21) is operated to add an image specified in the file name selection dialog box 80 to what is being displayed in the representative image file name display region 62. Specifically, the add button 64 is used to give an instruction to add the image as a representative image. The delete button 65 is used to give an instruction to delete a representative image already set. Selecting a file name displayed in the representative image file name display region 62 and subsequently operating the delete button 65 results in deleting the image of that file from the representative images.

The OK button 66 is used to end the sequence of operations while saving the results set at the representative image specification dialog box 60. The cancel button 67 is used to end the sequence of operations without saving the set results. When the sequence of operations is ended through the operation of the Ok button 66, the set results are immediately reflected on the personal computer 2, so that the representative images displayed superimposed on the image of the folder on the search screen 50 becomes those set at the representative image specification dialog box 60.

The representative image display check box 68 is used to specify whether or not a representative image is to be displayed superimposed on the image of the folder. When the user does not want a representative image to be displayed superimposed on the image of the folder on the search screen 50, the user can operate this check box to display only the image of the folder. The representative image storage check box 70 is used to specify whether or not to store in a file the relationship between the representative image set at the representative image specification dialog box 60 and the folder. This file is created in the form of a text file in the folder, so that the file can be used by being referred to from various application programs.

The file display check box 69 is used to specify whether to display the file names of all the image files stored in the folder or the files names of only those stored in the folder which contains data recorded to mark a representative image. The sort method selection region 71 and the sort direction selection region 72 display items on the basis of which to specify the order in which the file names are to be displayed in the file name display region 82 of the file name selection dialog box 80. The sort method selection region 71 displays five items including “by attribute”, “by name”, “by date”, “by size”, and “by extension”. The sort direction selection region 72 displays 2 items including “ascending order” and “descending order”. The user can freely select from among the items.

The order in which the representative images are displayed superimposed side-by-side on the image of the folder corresponds to the order in which the file names are displayed in the representative image file name display region 62 of the representative image specification dialog box 60. In the representative image file image display region 62, the file names are displayed in the order in which the file names have been added through the operation of the add button 64. The user can change the order of the file names displayed in the representative image file name display region 62 by selecting and moving a file name therein. In this way, the user can change the order in which the representative images are displayed superimposed side-by-side on the image of the folder. This function allows, when there exist more than a predetermined number of representative images that can be displayed at once, a representative image that has not been displayed to be newly displayed.

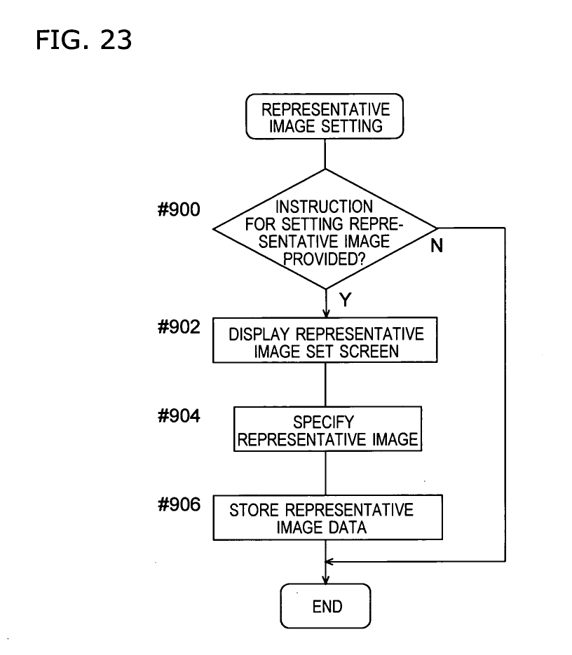

FIG. 23 shows the flow of operations performed to set a representative image. First, it is checked whether or not an instruction for setting a representative image is given through the operation of the representative image specify button 53 (step #900). If the instruction is not given, the sequence of the operations ends. If the instruction for setting a representative image is given, the above-mentioned representative image specification dialog box 60 is displayed to permit the setting of a representative image (#902), and the specification of the representative image is accepted (#904). Then, data related to the specified representative image is stored (#906), thereby ending the sequence of the operations.

Obviously, many modifications and variations of the present invention are possible in light of the above teachings. It is therefore to be understood that within the scope of the appended claims, the invention may be practiced other than as specifically described.

What is claimed is:

1. A digital camera for storing photographed images as image files in a folder created on a recording medium,
wherein the digital camera specifies the image of one of the image files stored in the folder as a representative image that represents all the image files stored in the folder, and records, in the image file of the representative image, data that marks a representative image.

2. The digital camera of claim 1,
wherein the data that marks a representative image is recorded in a tag of the image file.

3. The digital camera of claim 1,
wherein the images of the image files stored in the folder are displayed side-by-side in response to an instruction given by a user, and, if the representative image is included in the displayed images, an indication that marks a representative image is added to the representative image.

4. The digital camera of claim 1,
wherein the images of the image files stored in the folder are displayed side-by-side to permit the user to specify one of the displayed images so that the specified image is determined as the representative image.

5. The digital camera of claim 1,
wherein, as the representative image, images of a plurality of image files stored in the folder can be determined.

6. The digital camera 1 of claim 1,
wherein the digital camera has a photographing mode in which a newly photographed image is associated with the image of one of the image files stored in the folder and data indicating association between the images is recorded on the recording medium, and
wherein, when an image is photographed in the photographing mode, the image with which the newly photographed image is associated is determined as the representative image.

7. The digital camera of claim 1,
wherein, as said folder, a plurality of folders are created on the recording medium, and representative images are specified on a folder-by-folder basis.

8. A program for making a computer search a recording medium of a digital camera that stores photographed images as image files in a folder created on the recording medium so as to display an image of the folder created on the recording medium, the program comprising commands for making the computer execute:
a first step of checking whether or not any of the image files stored in the folder contains data recorded to mark the image of said image file as a representative image that represents all the image files stored in the folder; and
a second step of displaying, if none of the image files stored in the folder contains data recorded to mark a representative image, only the image of the folder or, if any of the image files stored in the folder contains data recorded to mark a representative image, the image of said image file in a manner superimposed on the image of the folder.

9. The program of claim 8,
wherein it is checked in the first step whether or not data that marks a representative image is recorded in a tag of the image file.

10. The program of claim 8,
wherein, if a number of image files containing data recorded to mark a representative image is equal to or less than a predetermined number, images of all these image files are displayed in the second step.

11. The program of claim 8,
wherein, if a number of images containing data recorded to mark a representative image exceeds a predetermined number, in the second step, of all images of these image files, only images of the predetermined number of image files are displayed while a number of remaining image files is displayed along the image of the folder.

12. The program of claim 8,
wherein, if, as said folder, a plurality of folders storing image files are created on the recording medium, images of the folders are displayed side-by-side in the second step.

13. A program for making a personal computer read, from a recording medium of a digital camera that stores photographed images as image files in a folder created on the recording medium, image files into a folder created in a storage portion of the personal computer and then display an image of the folder created in the storage portion, the program comprising commands for making the computer execute:
a first step of checking whether or not any of the image files stored in the folder in the storage portion contains data recorded to mark the image of said image file as a representative image that represents all the images of the image files stored in the folder; and
a second of displaying, if none of the image files stored in the folder contains data recorded to mark a representative image, only the image of the folder, or if any of the image files stored in the folder contains data recorded to mark a representative image, the image of said image file in a manner superimposed on the image of the folder.

14. The program of claim 13,
wherein it is checked in the first step whether or not data that marks a representative image is recorded in a tag of the image file.

15. The program of claim 13,
wherein, if a number of image files containing data recorded to mark a representative image is equal to or less than a predetermined number, images of all these image files are displayed in the second step.

16. The program of claim 13,
wherein, if a number of image files containing data recorded to mark a representative image exceeds a predetermined number, in the second step, of all images of these image files, only images of the predetermined number of image files are displayed while a number of remaining image files is displayed along the image of the folder.

17. The program of claim 13,
wherein, as said folder, a plurality of folders storing image files are created in the storage portion so that images of the folders are displayed side-by-side in the second step.
